(19) United States
(12) Patent Application Publication
(10) Pub. No.: US 2005/0202282 A1
(43) Pub. Date: Sep. 15, 2005

(54) Manufacturing process for a refractory material, protective coating that can be obtained with this process and uses of this process and this coating

(75) Inventors: Pierre Lespade, Merignac (FR); Paul Goursat, Veruciel / Vierus (FR); Nicolas Richet, Fontenayale Flury (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: EADS SPACE TRANSPORTATION SA, Paris (FR)

(21) Appl. No.: 10/628,356

(22) Filed: Jul. 29, 2003

(30) Foreign Application Priority Data
Jul. 30, 2002 (FR) 02 09677

(51) Int. Cl. B32B 9/00; C04B 35/577

(52) U.S. Cl. 428/698; 501/92

(57) ABSTRACT

This invention relates to a process for manufacturing a refractory material, a protective coating, and uses of this process and this coating. The process comprises the following steps: a) deposit on the surface of a substrate or in a mould a first dispersion containing at least one metallic compound chosen from among borides, carbides and borocarbides containing at least one transition metal, in powder form, and a resin with a coke mass content equal to at least 30% after carbonization; b) dry the resulting deposit; c) cross-link the resin; d) carbonize the resin under an inert atmosphere; e) cover the deposit with a second dispersion containing Si in powder form and a binder; f) heat the deposit to a temperature greater than or equal to the melting temperature of Si, under an inert atmosphere. Applications: manufacture of propulsion parts and fuselage and wing elements for aerospace and aeronautical applications; manufacture of heat exchangers for thermal power stations; metallurgy; chemical industry; etc.

### TECHNICAL DOMAIN

This invention relates to a process for manufacturing a refractory material that is capable of resisting corrosion and more particularly oxidation when it is placed in an oxidizing environment at very high temperatures (above 1000° C.), a protective coating that can be obtained by this process, and uses of this process and this coating.

The process that can equally well be used to make solid parts or to produce coatings for protecting solid parts against corrosion, can be used for aerospace and aeronautical applications, for example for making propulsion parts (turbines, nozzles, etc.) and fuselage and wing elements exposed to severe oxidation in flight such as leading edges of space shuttles or aircraft, in thermal power stations, for example for making heat exchangers and more generally in any industry in which there are particularly severe thermal and mechanical constraints (metallurgy, chemical industry, automobile industry, etc.)

### STATE OF PRIOR ART

Known methods include the use of metallic borides and carbides, and particularly hafnium and zirconium borides and carbides, in combination with silicon carbide to make either solid refractory ceramics, or coatings suitable for protecting carbon-based parts against oxidation at very high temperatures.

Thus for example:
U.S. Pat. No. 3,775,137 [1] discloses solid ceramics composed of a metallic boride—preferably zirconium boride—combined with silicon carbide;
U.S. Pat. No. 5,750,450 [2] discloses solid ceramics that supposedly have better resistance to corrosion at high temperature than earlier ceramics derived from more complex mixtures comprising two, three or even four compounds chosen from among hafnium and zirconium borides and carbides in combination with silicon carbide; while
EP-A-0 675 863 [3] from the Applicant proposes to use a mixture of hafnium boride and silicon carbide to coat the surface of a material or an article made of carbon in order to protect it from oxidation at temperatures of between 1700 and 2000° C.

The solid ceramics described in the American patents mentioned above are obtained by processes that consist of mixing the different constituents (ZrB₂, HfB₂, SiC, etc.) in powder form, possibly in the presence of a solvent, and then pouring the resulting mixture into a mould, drying it if it contains a solvent, and then hot pressing it (in other words at temperatures of the order of 2000° C.) for long enough for the material density to be equal to at least 95% of the required density of the ceramics when they are complete.

Obviously, this hot pressing operation cannot be used to make protective coatings on substrates.

This is why the protective coating described in EP-A-0 675 863 is obtained by a process that consists of depositing a powder mixture of hafnium boride and carbon boride on the surface to be protected starting from a slurry, drying this deposit and then exposing the said surface to silicon vapors under a partial vacuum at 1850° C., to induce a reaction between the carbon present in the deposit and this silicon, and consequently the formation of silicon carbide.

The document mentioned in the above paragraph is not the only document to disclose a reaction between carbon and silicon to put silicon carbide into place in a material. Thus, processes using a reactive infiltration of silicon have also been described in FR-A-2 551 433 [4], U.S. Pat. No. 4,385,020 [5] and U.S. Pat. No. 6,126,749 [6] for the production of solid silicon carbide ceramics and FR-A-2 790 470 [7] for the production of silicon carbide composites reinforced by fibers, the silicon being added by dipping a carbonaceous preform into a molten silicon bath (for example as in U.S. Pat. No. 6,126,749) or by coating carbon particles with a siliceous powder and then melting this powder (for example as in U.S. Pat. No. 4,385,020) depending on the case.

In general, processes using a C+Si reaction proposed so far are incapable of controlling carbon and silicon quantities made to react, even though this reaction must be as stoechiometric as possible in order to minimize residual quantities of carbon and silicon present in the final material.

The use of excess silicon over carbon leads to the presence of free silicon in the final material, which is chemically very undesirable since this silicon either oxidizes to silica which melts at about 1600° C., or it melts before it oxidizes since its own melting temperature is 1410° C. In any case, this may cause the formation of porosity that can allow oxygen to enter this material or at least to disturb its properties, particularly in terms of its viscosity, refractoriness or mechanical properties.

Similarly, the use of excess carbon over silicon leads to the presence of free carbon in the final material which is just as undesirable, since oxidation of this carbon can also be responsible for the formation of porosity and consequently a sealing defect and a deterioration of the mechanical properties.

Thus, if silicon is added by dipping a carbonaceous preform into a molten silicon bath, it is very difficult to control the quantity of silicon that might remain on the faces of the preform when it is taken out of the bath, and it is even more difficult to control the quantity of free silicon that might remain in the material once it has been completed. This is a problem particularly when the preform is not very thick (the ratio between the quantity of free silicon and the material volume being correspondingly high), which is the case particularly when a protective coating is made.

Infiltration of silicon in the vapor phase is not much simpler to control and experience shows that the result is an excess of free silicon on the surface of the material.

Moreover, very special purpose furnaces are necessary since they have to be able to operate at very high temperatures and at low pressure, and therefore they are particularly expensive, particularly if the parts to be made or protected are large or if their shapes are complex.

Furthermore, most processes using a C+Si reaction proposed up to now require that carbon should be added and made to react in powder form. In this case, silicon carbide is also in the form of particles in the final material (the C+Si reaction occurs on each carbon particle), and a porosity is developed between these particles with all the undesirable consequences mentioned above.

Therefore, the inventors set themselves the objective of providing a process for making a refractory material based on metallic boride(s) and/or carbide(s) and silicon carbide, that does not have the disadvantages of the processes mentioned above, and particularly it can result in a homogeneous material, with the lowest possible contents of free carbon and silicon, with remarkable oxygen barrier properties, even at very high temperatures, in that it is equally suitable for making protective coatings and for making solid parts, regardless of the size and shape of the parts to be protected or manufactured, and it can be used without any particularly expensive special purpose equipment.

These purposes are achieved by this invention, which discloses a process for making a refractory material.

Presentation of the Invention

The process according to the invention is characterized in that it comprises the following steps:
a) deposit on the surface of a substrate or in a mould a first dispersion containing at least one metallic compound chosen from among borides, carbides and borocarbides containing at least one transition metal, this compound being in powder form, and a resin with a coke mass content equal to at least 30% after carbonization,
b) dry the resulting deposit,
c) cross-link the resin in this deposit,
d) carbonize the said resin under an inert atmosphere,
e) cover the said deposit with a second dispersion containing silicon in powder form and a binder, and
f) heat the deposit made in step e) to a temperature equal to at least the melting temperature of silicon, under an inert atmosphere,
   steps a) and b) possibly being repeated one or several times before going on to step c).

Thus, like processes according to the state of the art mentioned above, the process according to the invention uses a reactive infiltration of silicon, but unlike previous processes, carbon and silicon are added by depositing dispersions (commonly referred to as “slurries” in the ceramic manufacturing field), and in this way the quantities of carbon and silicon made to react can be controlled by controlling the composition of these dispersions and by the mass per unit area of the deposits.

Furthermore, the process according to the invention provides a means of adding carbon in the form of a resin that is mixed with the powder metallic compound and is then carbonized so as to be reduced into coke, which initially forms a coating of the particles of the said compound by carbon, and then after reactive infiltration of silicon, forms a coating of these same particles with silicon carbide.

The result is a highly homogeneous material with very low contents of free carbon and silicon.

As mentioned above, the process according to the invention comprises firstly deposition of a first dispersion or “slurry” containing at least one metallic compound chosen from among borides, carbides and borocarbides comprising at least one transition metal, in powder form, and a resin with a coke content by mass equal to at least 30% after carbonization, onto the surface of a substrate or a mould (depending on whether a protective coating or a solid part is to be made).

For the purposes of this invention, a “metallic compound chosen from among borides, carbides and borocarbides comprising at least one transition metal” means any compound resulting from the reaction between boron and/or carbon and one or more metals in columns 3 to 12 in the Periodic Table of Elements, also known as Mendeleïev's Classification.

Examples of such compounds include borides and carbides of titanium (TiB₂, TiC), vanadium (VB₂, VC), chromium (CrB₂, Cr₃C₂), zirconium (ZrB₂, ZrC), niobium (NbB₂, NbC), molybdenum (Mo₂B₆, Mo₂C), hafnium (HfB₂, HfC), tantalum (TaB₂, TaC), tungsten (WB, WB₂, WC), titanium borocarbide (TiB₄C), tantalum-hafnium carbide (Ta₄HfC₅), tungsten-titanium carbide (WTiC₂) and tungsten-cobalt carbides (WC with 6% of Co, WC with 12% of Co, etc.).

Preferably, the metallic compound is chosen from among hafnium, zirconium and titanium borides and carbides, these components having excellent refractoriness properties.

Furthermore, the term “resin with a coke mass content equal to at least 30% after carbonization” means any thermosetting or thermoplastic polymer for which carbonization leads to a coke with a mass equal to at least 30% of the resin mass after cross linking and before carbonization.

Preferably, the coke mass content of the resin is equal to at least 45% after carbonization and is chosen from among phenolic resins and furanic resins.

Examples of resins that could be used in the process according to the invention include phenolic resin marketed by the RHODIA Company as reference RA 101 and furanic resin FRD 5129 marketed by the BORDEN company.

According to the invention, the metallic compound is preferably present in the first dispersion in the form of particles with an average diameter of less than or equal to 5 μm. This means that if the metallic compound to be used does not have this size grading, then it should be ground before it is mixed with the resin. This grinding is advantageously done after this compound has been dispersed in a solvent in the presence of a dispersant, for example a phosphoric ester or a mixture of phosphoric esters, to avoid the particles of the said compound from forming lumps with each other and precipitating.

After this grinding, the resin can be added to the metallic compound dispersion and the mixture can be made homogeneous, which is easier if the solvent initially chosen for grinding the metallic compound is a solvent in which this resin can be dissolved.

Once the deposit of the first dispersion has been made, the process according to the invention includes a step to dry this deposit in order to eliminate the solvent contained in it. Depending of the volatility of the solvent, drying may be done simply by allowing the solvent to evaporate into the open air, or by using a heated containment such as a drying oven.

According to the invention, it is then possible to make a new deposition of the first dispersion followed by drying, as many times as necessary as a function of the thickness required for this material.

As a variant, it is also possible to go on to the next step that consists of cross-linking the resin present in the deposit in order to increase its stiffness.

The resin is then carbonized in order to reduce it into coke. This operation is carried out under an inert atmosphere, in other words under nitrogen, argon, neon or a similar atmosphere, to prevent the carbon produced by the resin from reacting with the oxygen in the atmosphere. Furthermore, it is preferably carried out at high temperature (in practice, at a temperature equal to at least 900° C.) to more easily eliminate the main impurity atoms (O, N, S and partially H).

The process according to the invention then includes a step consisting of covering the deposit(s) made with the first dispersion by a second dispersion that contains silicon in powder form and a binder, the function of the binder being to enable a uniform distribution and to hold this silicon on the subjacent deposit.

Preferably, this binder is a solution containing about 5% (m/m) of carboxymethylcellulose and forms the liquid phase of the second dispersion.

Finally, the process according to the invention allows for heating the deposit made with the second dispersion to a temperature equal to at least the melting temperature of silicon (1410° C.) under an inert atmosphere, such that the silicon can infiltrate in liquid form within the thickness of the subjacent deposit(s) and react with carbon derived from carbonization of the resin to form silicon carbide.

The process according to the invention has proven to be particularly suitable for making a coating designed to protect a part from oxidation at very high temperatures, and in particular a carbon-based part. Infiltration of silicon in liquid form enables the silicon to reach the interface between the coating and the subjacent part, and react with the carbon present on the surface of this part to form an in-situ layer of silicon carbide.

This latter provides a chemical and mechanical bond of the coating onto the carbonated part that it is intended to protect, and eliminates the need for prior deposition of an intermediate layer on the surface of this part, for example a silicide layer in the case of a C/C composite, capable of creating mechanical compatibility between the said coating and the said part, particularly when their coefficients of expansion are very different.

Also in one preferred embodiment of this process, in step a), the substrate on which the first dispersion is deposited is a part composed of graphite or a composite material comprising a carbon or silicon carbide matrix, and carbon or silicon carbide fibers (C/C, C/SiC, SiC/C and SiC/SiC composites).

Like the second dispersion, this deposit may be made either by dipping the part in the dispersions, or by spraying the dispersions on this part.

However as a variant, the process according to the invention may also be used to make a solid part, in which case the two dispersions are deposited by pouring in an appropriate mould.

According to the invention, it is preferred to make a material containing 50 to 95% (m/m) of hafnium boride and 5 to 50% (m/m) of silicon carbide, this type of material potentially being among materials based on metallic borides and/or carbides and silicon carbide, which have the highest and most durable resistance to high temperatures.

In this case, the hafnium boride and resin contents of the first dispersion are such that at the end of step d) the mass ratio between hafnium boride and carbon derived from carbonization of the resin varies from 18:1 to 1:1, taking account of the mass ratio of coke in the said resin after carbonization, while the content of silicon in the second dispersion is such that at the end of step e) the molar ratio between the carbon derived from carbonization of the resin and the deposited silicon is equal to 1 or is only very slightly different from 1, taking account of the mass per unit area of the deposit made with this second dispersion.

The process according to the invention has many advantages, including:
it is a means of obtaining a refractory material with an extremely high resistance to corrosion at very high temperatures, particularly due to its homogeneity and the very low contents of free carbon and silicon contained in it;
it provides an opportunity to make this material either in the form of a coating to protect a part, or in the form of a solid part;
if it is used to make a protective coating on a carbon-based part, it is a means of eliminating the need to insert an intermediate layer between this coating and the part, to ensure mechanical compatibility between them, which results in a financial saving;
it is easy to implement since preparation of slurries and their deposition on the surface of a substrate or in a mould are operations that are easy to execute;
the heat treatments involved may be carried out in furnaces with no specific arrangements other than the presence of a neutral atmosphere, which is economically very attractive;
therefore, it is equally suitable for production in series and for production of large parts with complex shapes.

Considering the above, another purpose of this invention is the use of a process like that defined above for making coatings intended to protect a carbon-based part from corrosion at very high temperatures, and particularly to protect a part composed of graphite or a composite material comprising a matrix and fibers in carbon and/or silicon carbide.

This type of coating is particularly advantageous for aerospace and aeronautical applications, either to protect parts used in the composition of propulsion systems or to protect structural parts such as the fuselage and the wing of spacecraft and aircraft.

Another purpose of this invention is a protective coating containing hafnium boride and silicon carbide, characterized in that it can be obtained by the process just described above.

According to one preferred embodiment of this coating, it contains 50 to 95% (m/m) of hafnium boride and 5 to 50% (m/m) of silicon carbide.

Finally, another purpose of this invention is the use of this protective coating to protect a carbon-based part from corrosion at very high temperatures, and particularly a part composed of graphite or a composite material comprising a matrix and fibers in carbon and/or silicon carbide.

Apart from the measures described above, the invention includes other measures that will become clear in the remainder of the description which is given for illustrative purposes and is in no way limitative, with reference to the attached drawings.

### BRIEF DESCRIPTION OF THE DRAWINGS

FIG. 1 represents the distribution of the size of pores in five HfB₂/SiC monoliths made by the process according to the invention, at the end of step d) of this process.

FIG. 2 shows two photographs, A and B respectively, taken with a scanning electron microscope with two different magnifications (150× and 500×) of a cross section through an HfB₂/SiC coating made using the process according to the invention on a C/C composite substrate.

FIG. 3 shows two photographs, A and B respectively, taken with a scanning electron microscope, with two different magnifications (150× and 500×) of a cross section through an HfB₂/SiC coating made using the process according to the invention on a graphite substrate.

FIG. 4 shows two photographs, A and B respectively, taken with a scanning electron microscope, with two different magnifications (500× and 1500×) of a cross section through an HfB₂/SiC coating made using the process according to the invention on a C/C silicide composite substrate.

FIG. 5 shows a photograph taken with a scanning electron microscope of a cross section through a monolith made by the process according to the invention.

FIG. 6 shows the change in the variation of the mass per unit area (mg/cm²) of a monolith made using the process according to the invention, as a function of the temperature (°C.) when the temperature is increased linearly while blowing an O₂/He mixture with 20% (v:v) of O₂.

FIG. 7 shows the change in the variation of the mass per unit area (mg/cm²) of a monolith made using the process according to the invention, as a function of time (hours) when it is kept at 800° C., 1000° C., 1450° C. and 1600° C., while blowing an O₂/He mixture at 20% (v:v) of O₂.

FIG. 8 shows a photograph taken with a scanning electron microscope with a magnification of 500×, of a cross section through a monolith made by the process according to the invention, after 10 hours oxidation at 1600° C. while blowing a mixture of O₂/He at 20% (v:v) of O₂.

### EXAMPLE 1

### Production of HfB₂/SiC Materials Using the Process According to the Invention

HfB₂/SiC materials are made using the process according to the invention using a first dispersion containing hafnium boride and a phenolic resin, and a second dispersion containing silicon and an aqueous solution of 5% of carboxymethylcellulose as a binder.

These materials are made either:
in the form of coatings by deposition of dispersions on substrates composed of graphite or a C/C or C/C silicide composite material (in other words for which the surface has been covered by a layer of silicon carbide as described in FR-A-2 611 198 [8]),
or in the form of monoliths.

Operating methods are described below.

1.1—Preparation of the HfB₂ and Phenolic Resin Dispersion

50 g of HfB₂ powder, 7 g of ethanol and 0.2 g of a mixture of monoester and a diester, phosphoric ester (CECA ATOCHEM—reference Beycostat C213) were added in the jar of a semi-planetary grinder with five tungsten carbide balls, four of which have a diameter of 1 cm and one of which has a diameter of 2 cm.

Grinding is continued for 6 hours, after which 8 g of a phenolic resin (RHODIA—reference RA101) and 2 g of ethanol are added into the grinding jar and grinding is continued for one minute to obtain a homogeneous dispersion.

1.2—Preparation of the Silicon and Binder Dispersion

40 g of Si powder and 25 g of an aqueous solution (demineralized water) with 5% carboxymethyl-cellulose are added in a 50 ml beaker. This beaker is then put into an ice bath and an ultrasound probe is placed 0.5 cm from the bottom of the beaker. The dispersion is subjected to ultrasounds, in a BIOBLOC SCIENTIFIC sonicator, type Vibracell, model 72441, for 5 times one minute separated by intervals of one minute allowing it to stand.

1.3—Deposition of the HfB₂ and Phenolic Resin Dispersion

For coatings, the dispersion containing hafnium boride and phenolic resin is deposited by dipping the substrates in this dispersion and taking them out at constant speed. The thickness of the depositions thus made is approximately 50 μm on the graphite and 100 μm on composite substrates.

In the case of monoliths, the dispersion is deposited by pouring it on a coated paper sheet itself placed on a metallic plate. The dispersion is forced to spread by tilting the metallic plate so as to obtain the thinnest possible deposits. The thickness of the deposits thus made is between 200 and 400 μm.

1.4—Drying the Deposits

The deposits are dried in a drying oven with an internal temperature of 60° C. until the ethanol has been completely eliminated.

1.5—Cross-Linking the Phenolic Resin

The phenolic resin is cross-linked in a drying oven in air with an internal temperature of 180° C., increased at a rate of 9° C. per minute, and is kept at this value for 1 hour. Cross-linking is followed by uncontrolled cooling.

1.6—Carbonizing the Phenolic Resin

The phenolic resin is carbonized in a furnace under a nitrogen atmosphere with an internal temperature of 1200° C., increased at a rate of 10° C. per minute and is kept at this value for one hour. Carbonization is followed by uncontrolled cooling.

1.7—Deposition of the Silicon and Binder Dispersion

The dispersion containing the silicon and the binder is deposited in the same way as the dispersion containing hafnium boride and phenolic resin.

1.8—Reactive Infiltration of Silicon

The reactive infiltration of silicon is made in a furnace under an argon atmosphere in which the internal temperature is increased to 1430° C. increased at a rate of 10° C. per minute and is kept at this value for one hour.

After this treatment, simple brushing eliminates the layer of silicon carbide powder that formed on the surface of the materials and the excess silicon present on this surface.

### EXAMPLE 2

### Analysis of the Microstructure of the Materials made in Example 1

The microstructure of the materials made in example 1 is evaluated firstly by analyzing the distribution of pore sizes in these materials after carbonization of the phenolic resin, and secondly by an examination with a scanning electron microscope (SEM).

2.1—Distribution of Pore Sizes

The distribution of pore sizes of the five monoliths (M1, M2, M3, M4 and M5 respectively) prepared under identical conditions, is determined after carbonization of the phenolic resin using the mercury intrusion technique. This is done using a mercury porositymeter made by MICROMERICS Asap 2000;

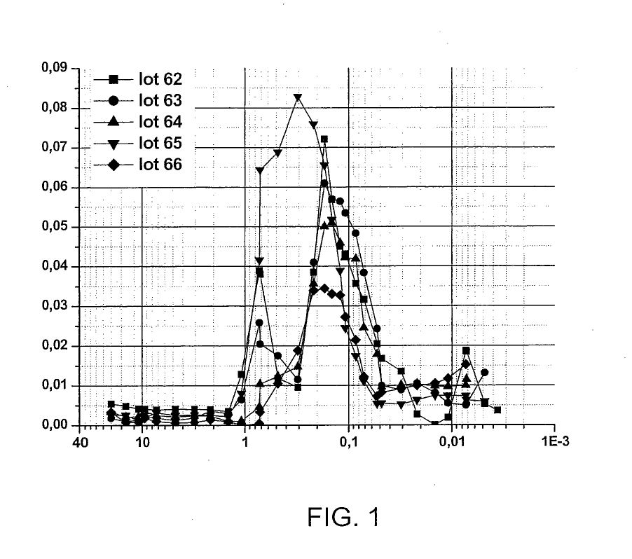

The results are illustrated in graphic form in FIG. 1, in which the ordinates axis represents the logarithmic derivative of the mercury intrusion volume, while the abscissas axis shows the pore size expressed in μm.

This figure shows that the distribution of the porosity of the five monoliths is very uniform in different monoliths, which confirms the excellent reproducibility of the porous microstructure of materials made by the process according to the invention.

2.2—Examination with a SEM

The SEM examination of the microstructure of the materials is made on cross sections of these materials, and for coatings, of the substrates on which the coatings are made, using a LEICA Stereoscan 360FE microscope.

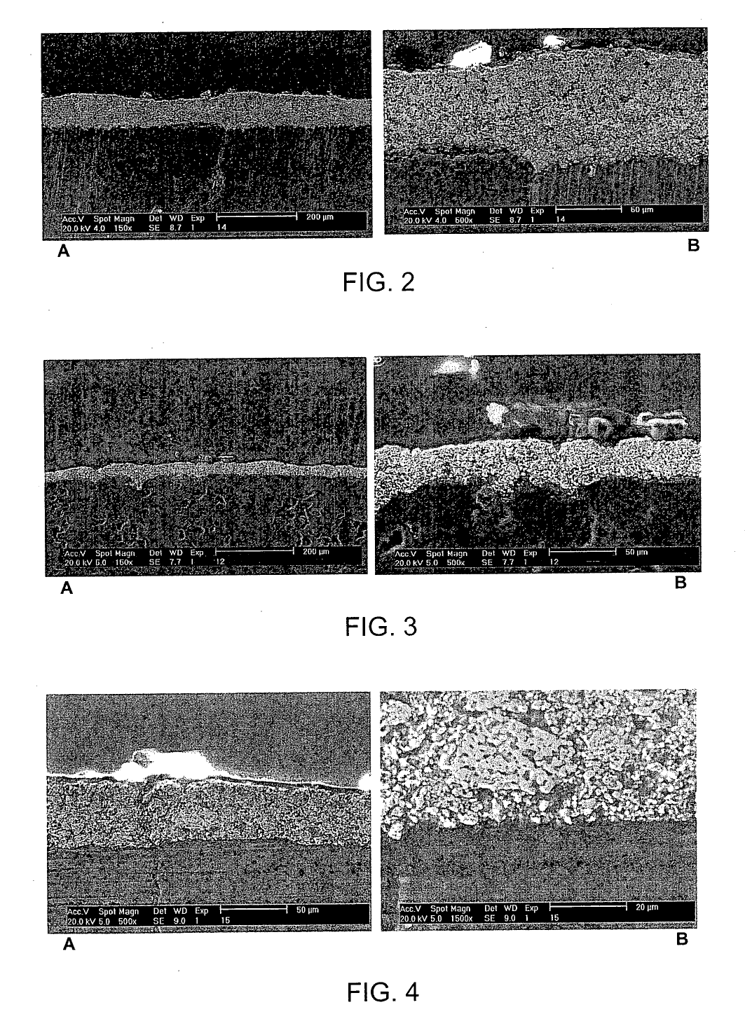

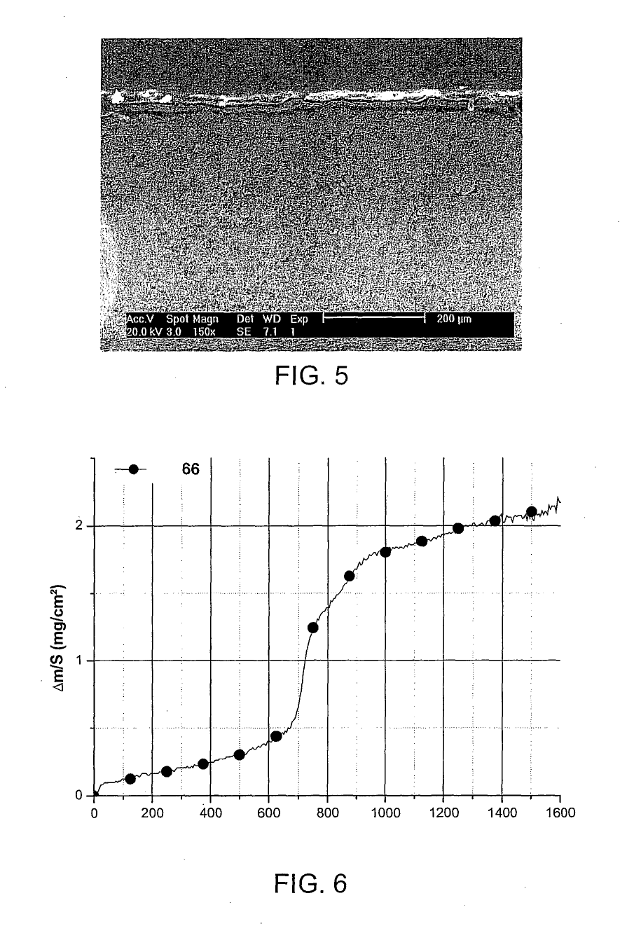

The results are illustrated in FIGS. 2 to 5 that show:
FIG. 2: photographs of a coating made on a C/C composite substrate, photograph A showing a magnification of 150× and photograph B showing a magnification of 500×;
FIG. 3: photographs of a coating made on a graphite substrate, photograph A showing a magnification of 150× and photograph B showing a magnification of 500×;
FIG. 4: photographs of a coating made on a C/C silicide composite substrate, photograph A showing a magnification of 150× and photograph B showing a magnification of 500×; and
FIG. 5: the photograph of a monolith taken at a magnification of 500×.

These figures show that materials made using the process according to the invention have a relatively dense composite microstructure that is very homogeneous, composed of HfB₂ grains bound by a silicon carbide matrix, regardless of whether they are monoliths or coatings and if they are coatings, regardless of the nature of the subjacent substrate and whether or not it is silicided.

Thus, this example confirms that the process according to the invention, if it is used to make a protective coating on a carbonaceous substrate of the C/C composite type, can eliminate the need for prior placement of a layer in order to assure mechanical compatibility between this coating and the said substrate.

### EXAMPLE 3

### Study of the Performances of Materials Made in Example 1

The suitability of the materials made in example 1 to resist oxidation at very high temperatures is evaluated by monitoring the variation of mass per unit area of monolith M5 when this monolith is subjected firstly to a linear temperature rise (from 0 to 1600° C.) in an oxidizing environment, in other words blowing an O₂/He mixture with 20% (v:v) of O₂, and secondly kept at the same temperature (800, 1000, 1450 or 1600° C.) for several hours in this same oxidizing environment.

Since these materials are essentially composed of HfB₂ and SiC, the following reactions can occur in the presence of oxygen:
1) HfB₂ (s)+(5/2)0₂ (g)--→HfB₂ (s)+B₂O₃ (S)
2) Sic (s)+(3/2)0₂ (g)--→SiO₂ (S)+CO (g)
   each of which results in an increase of the mass (Δm>0).

Moreover, it is known that boron trioxide (B₂O₃) resulting from the oxidation of hafnium boride forms a first oxygen diffusion barrier starting from 450° C., and acts as a healing agent. The other oxidation products usually appear starting from 750° C. and form a borosilicated glass that can also improve the performances of the healing phase and particularly reduce its volatilization.

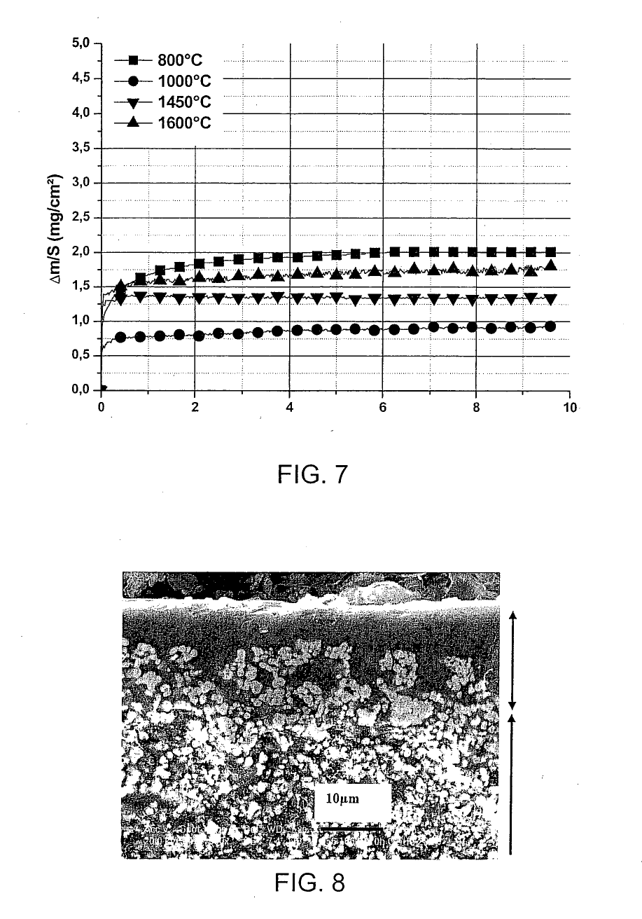

The results obtained are illustrated in FIGS. 6 and 7 that shown:
FIG. 6: the change in the variation of the mass (Δm) per unit area, expressed in mg/cm², of the M5 monolith as a function of the temperature expressed in ° C., when it is subjected to a linear temperature rise from 0 to 1600° C.;
FIG. 7: the change in the variation of the mass (Δm) per unit area, expressed in mg/cm², of the M5 monolith as a function of the time expressed in hours, when it is held for several hours at 800° C., 1000° C., 1450° C. and 1600° C.;
FIG. 8: a photograph taken with a SEM at a magnification of 1500×, of a cross section of this same monolith after oxidation for 10 hours at 1600° C.

FIG. 6 shows that the M5 monolith does not lose any mass between 450 and 650° C., which means that it does not contain any easily accessible free carbon that can react with the ambient oxygen. A substantial gain in the mass of the monolith is observed starting from 750° C., which is explained by the fact that oxidation firstly of hafnium boride and then of silicon carbide are accelerated, and quickly cause the fast formation of a vitreous, healing and protective layer.

FIG. 7 shows that regardless of the temperature at which the monolith M5 is held, oxidation is quickly blocked by the formation of the vitreous layer initially composed of boron trioxide and that becomes enriched in silicon dioxide and hafnium dioxide with time. This vitreous layer, for which the volatility is the main limitation for very high temperature applications, appears to be stable at least up to 1600° C. since no loss of mass is observed.

FIG. 8 shows that the approximately 20 μm thick vitreous layer is compact and heals perfectly.

1. Process for manufacturing a refractory material, characterized in that it comprises the following steps:
a) deposit on the surface of a substrate or in a mould a first dispersion containing at least one metallic compound chosen from among borides, carbides and borocarbides containing at least one transition metal, in powder form, and a resin with a coke mass content equal to at least 30% after carbonization;
b) dry the resulting deposit;
c) cross-link the resin present in this deposit;
d) carbonize this resin under an inert atmosphere;
e) cover the said deposit with a second dispersion containing silicon in powder form and a binder; and
f) heat the deposit made in step e) to a temperature equal to at least the melting temperature of silicon, under an inert atmosphere,
steps a) and b) possibly being repeated one or more times before going onto step c).

2. Process according to claim 1, characterized in that the metallic compound is chosen from among hafnium, zirconium and titanium borides and carbides.

3. Process according to claim 1 or claim 2, characterized in that the resin has a coke mass content equal to at least 45% after carbonization.

4. Process according to any one of the above claims, characterized in that the resin is chosen from among phenolic resins and furanic resins.

5. Process according to any one of the above claims, characterized in that the metallic compound present in the first dispersion is in the form of particles with an average diameter of less than or equal to 5 μm.

6. Process according to any one of the above claims, characterized in that the binder present in the second dispersion is an aqueous solution of about 5% (m/m) of carboxymethylcellulose.

7. Process according to any one of the above claims, characterized in that, in step a), the substrate on which the first dispersion is deposited is a part composed of graphite or a composite material comprising a matrix and fibers in carbon and/or silicon carbide.

8. Process according to any one of the above claims, characterized in that the metallic compound is hafnium boride and in that the hafnium boride and resin contents of the first dispersion are such that at the end of step d), the mass ratio between hafnium boride and carbon derived from carbonization varies from 18:1 to 1:1, taking account of the mass ratio of coke in the said resin after carbonization.

9. Process according to claim 8, characterized in that the silicon content of the second dispersion is such that, after step e), the molar ratio between the carbon derived from carbonization of the resin and the deposited silicon is equal to 1 or is only very slightly different from 1, taking account of the mass per unit area of the deposit made with this second dispersion.

10. Use of a process according to any one of claims 1 to 9 for making coatings intended to protect a carbon-based part from corrosion at very high temperatures.

11. Use according to claim 10, characterized in that the carbon-based part is composed of graphite or a composite material comprising a carbon or silicon carbide matrix and carbon and/or silicon carbide fibers.

12. Protective coating containing a metallic compound comprising hafnium boride and silicon carbide, characterized in that it can be obtained by a process according to any one of claims 1 to 9.

13. Protective coating according to claim 12, characterized in that it contains 50 to 95% (m/m) of hafnium boride and 5 to 50% (m/m) of silicon carbide.

14. Use of a protective coating according to claim 12 or claim 13 to protect a carbon-based part from corrosion at very high temperatures.

15. Use according to claim 14, characterized in that the carbon-based part is composed of graphite or a composite material comprising a matrix and fibers in carbon and/or silicon carbide.
